(19) United States
(12) Patent Application Publication
(10) Pub. No.: US 2016/0016517 A1
(43) Pub. Date: Jan. 21, 2016

(54) Intercepting Interior Side Mirror Assembly

(71) Applicant: LIJUAN SUN, Fremont, CA (US)

(72) Inventor: LIJUAN SUN, Fremont, CA (US)

(21) Appl. No.: 14/331,459

(22) Filed: Jul. 15, 2014

(51) Int. Cl. B60R 1/08; B60R 1/04

(52) U.S. Cl. CPC B60R 1/082; B60R 1/04

(57) ABSTRACT

A multiple layer angled mirror assembly to provide wide-angle view of side traffic status including blind spots for a vehicle. The mirror assembly will intercept out the interior image of B-pillar of the vehicle and the image beyond next lane to the vehicle. The mirror assembly presents a clear and desired side traffic view of the vehicle. The mirror assembly can be attached to the vehicle main rear mirror side with backing casing.

### BACKGROUND OF THE INVENTION

### Field of invention

The present invention relates to side mirror design for vehicles.

The prior rear view mirror systems still cannot cover the blind spot when driver operates a vehicle unless taking extra actions like turning eyes around. And it's impossible for driver to observe the traffic status of left and right blind spots simultaneously.

Therefore it is desirable and safer for the drivers to reduce head movements and to observe the rear and side traffic conditions without any blind spot.

The present invention can be equipped inside of a vehicle.

The function of the mirror assembly can eliminate the unwanted images—e.g.:
B pillar or other image beyond the next lane if the invention is installed inside of the vehicle.

The present mirror assembly presents a clear and desired side traffic status of the vehicle.

### BRIEF DESCRIPTION OF THE DRAWINGS

FIG. 1: Isometric front view of an embodiment of an interior side view mirror assembly in accordance with the present invention;

FIG. 2: Isometric side view.

FIG. 3: Top view of an embodiment.

FIG. 4: Isometric front side view of an embodiment.

FIG. 5: An example Interior side image of vehicle.

FIG. 6: Intercepted image of FIG. 5.

FIG. 7: Conceptual function illustration of intercepting mirror.

FIG. 8. Optical diagram of an intercepting mirror assembly

FIG. 9. An example of side mirrors attached to rear view mirror.

### DETAILED DESCRIPTION OF THE INVENTION

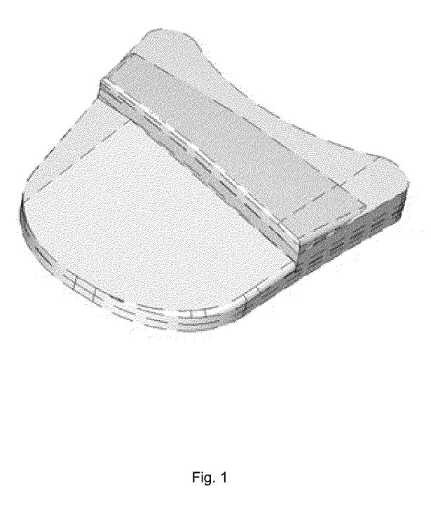

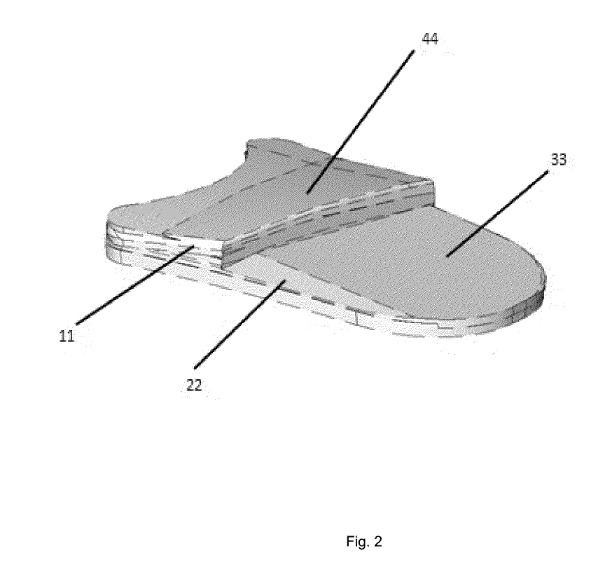

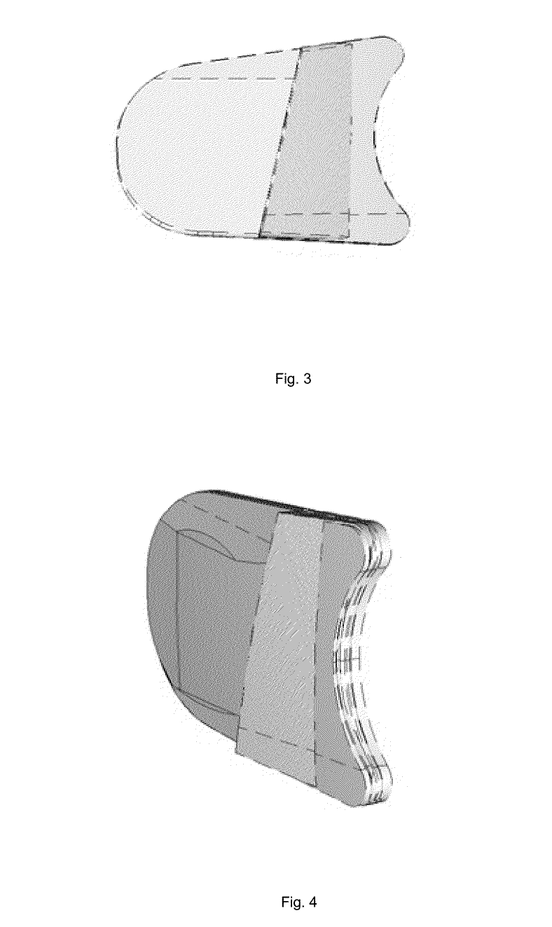

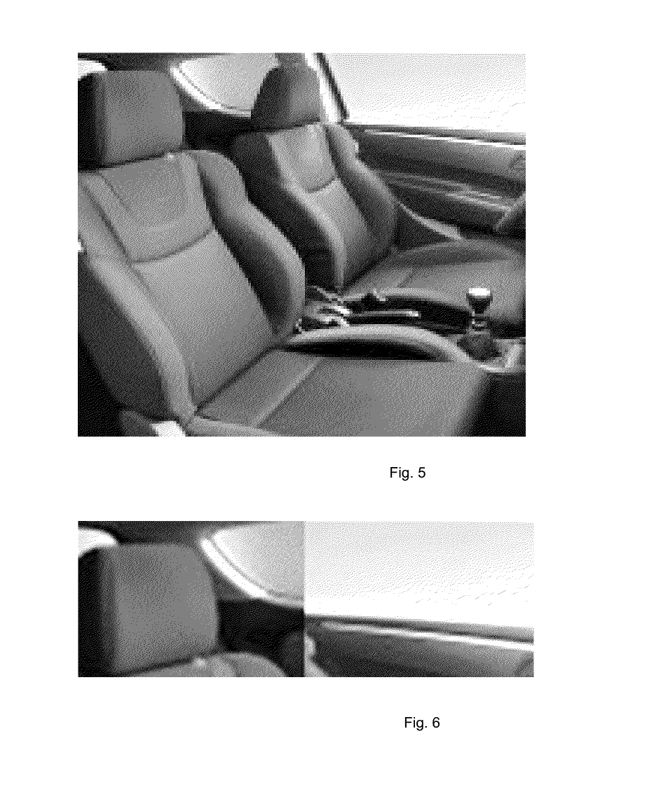

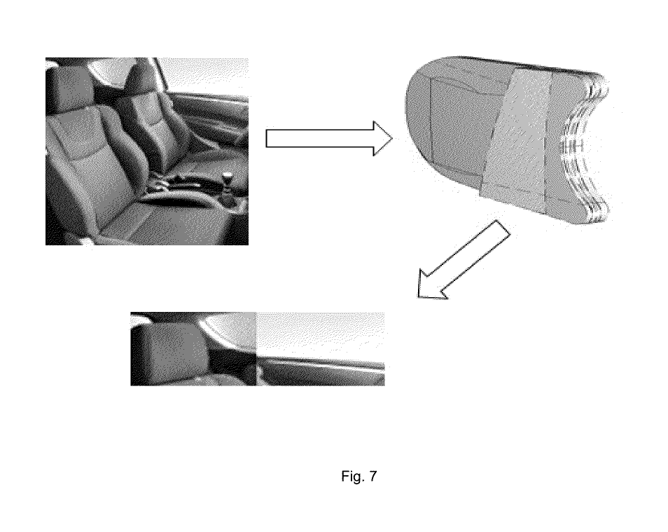

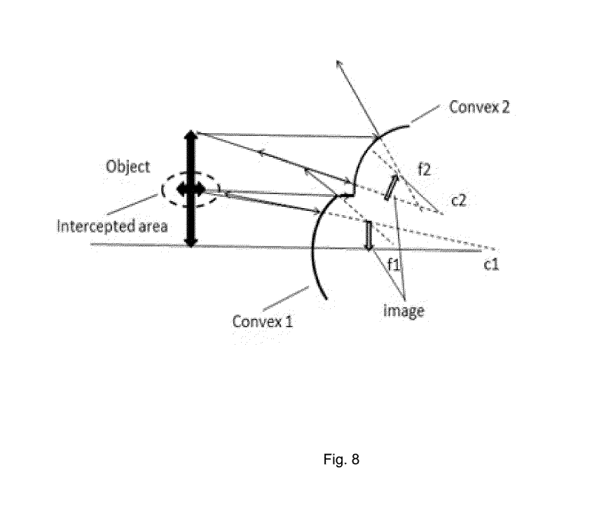

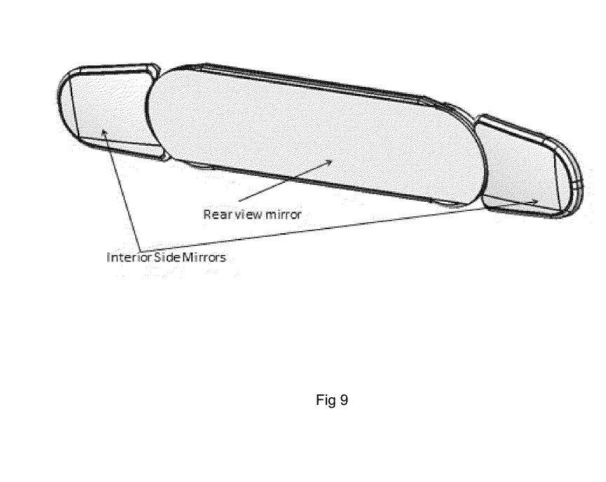

FIG. 1 is the isometric front view of an intercepting mirror assembly formed with a flat or convex mirror.
FIG. 2 is a mirror assembly with an angled convex mirror 44 where an angle 11 about 9-12 degrees is integrated into another convex or flat mirror 33 at lower level.
The Angle 22 is edged for eliminating the unwanted boundary area of image, to present the desired area for viewing.
FIG. 3 is a front view of the assembly.
FIG. 4 is a isometric side view of the assembly.
FIG. 5 is an example of interior side image of the vehicle.
FIG. 6 is the intercepted image of B pillar from FIG. 5
FIG. 7 is an illustrated conceptual function of intercepting mirror assembly.
FIG. 8 is an optical diagram of an intercepting mirror assembly.
FIG. 9 shows the related mounting positions among rear view mirror and side mirror assembles.

### SUMMARY OF THE INVENTION

The present invention is to provide vehicle drivers side image of traffic status without blind spots.
Accordingly, it is an object of present invention to provide the intercepted and selected area of the image reflected.
The present invention is interior apparatus of a vehicle for the owner to possess more security and convenience of the estate.

What is claimed is:

1. An intercepting mirror assembly, comprising:
A top flat or convex mirror integrated with designed angle to a flat or another convex mirror at lower layer position.

2. The intercepting mirror assembly provides the function to intercept out targeted area and to retain the rest of the images as desired.

3. The intercepting mirror assembly can intercept out the targeted area either at vertical or horizontal direction as designed.
